(19) United States
(12) Patent Application Publication
(10) Pub. No.: US 2010/0162729 A1
(43) Pub. Date: Jul. 1, 2010

(54) Liquid CO2 Passive Subcooler

(76) Inventors: Stephen A. McCormick, Warrington, PA (US); Michael D. Newman, Hillsborough, NJ (US)

Correspondence Address: The BOC Group, Inc., 575 MOUNTAIN AVENUE, MURRAY HILL, NJ, 07974-2082, US

(21) Appl. No.: 12/344,699

(22) Filed: Dec. 29, 2008

(51) Int. Cl. F17C 9/02

(52) U.S. Cl. 62/50.2

(57) ABSTRACT

A refrigeration process including supplying chilled CO₂ liquid into a refrigeration chamber, flashing the chilled CO₂ liquid into gaseous CO₂ and solid CO₂ for providing a cooling elect within the refrigeration chamber, and exhausting CO₂ gas from the refrigeration chamber, wherein fresh CO₂ liquid passes through a tube-side of a shell-and-tube heat exchanger prior to entering the refrigeration chamber as chilled CO₂ liquid and the exhaust CO₂ gas passes through a shell-side of the shell-and-tube heat exchanger after exiting the refrigeration chamber, thereby pre-cooling the liquid CO₂ prior to entering the refrigeration chamber.

### FIELD OF THE INVENTION

The present invention relates to utilizing energy contained in the gaseous refrigerant exhaust of a refrigeration chamber to pre-cool the liquid refrigerant entering the refrigeration chamber, resulting in a more efficient use of refrigerant.

### BACKGROUND

Conventional refrigeration processes take various structural forms and utilize various cooling processes. One such process utilizes pressurized liquid refrigerants, such as CO₂, which are flashed upon entering the refrigeration chamber. When CO₂ is utilized, the flash typically results in about 48% solid CO₂ and about 52% gaseous CO₂, at a temperature of about −109° F. (−78.3° C.). The solid CO₂ contacts the items which are to be frozen and sublimates, thereby extracting heat from the item to be frozen. Other refrigerants, such as N₂, act in a similar manner, except that the phase change usually results in a mixture of liquid and gas, and the cooling effect is provided by the liquid refrigerant evaporating upon contact with the item to be frozen.

Regardless of the refrigerant used, gaseous refrigerant must be exhausted from the refrigeration chamber. Such gaseous refrigerant typically exits the refrigeration chamber at temperatures which are much lower than the temperature at which the pressurized liquid refrigerant enters the refrigeration chamber. The gaseous refrigerant thus expels into the outside environment much of the energy used to produce the pressurized liquid refrigerant. Therefore, in order to increase the efficiency of such refrigeration chambers, it is desirable to harness the energy of the gaseous exhaust in order to pre-cool the liquid refrigerant before it enters the refrigeration chamber.

### SUMMARY

A refrigeration process is provided which includes supplying liquid CO₂ into a refrigeration chamber, flashing the liquid CO₂ into gaseous CO₂ and solid CO₂ to provide a cooling effect within the refrigeration chamber, and exhausting gaseous CO₂ from the refrigeration chamber, wherein the liquid CO₂ passes through a tube-side of a shell-and-tube heat exchanger prior to entering the refrigeration chamber, and the gaseous CO₂ passes through a shell-side of the shell-and-tube heat exchanger after exiting the refrigeration chamber, thereby pre-cooling the liquid CO₂ prior to entering the refrigeration chamber.

A refrigeration apparatus is provided, which includes a refrigeration chamber; a liquid CO₂ storage apparatus for providing liquid CO₂ at above atmospheric pressure to the refrigeration chamber for flashing into gaseous CO₂ and CO₂ snow; and a heat exchanger disposed between and in fluid communication with the storage apparatus and the refrigeration chamber for receiving and chilling the liquid CO₂ prior to said flashing; wherein the heat exchanger is a shell-and-tube heat exchanger adapted to receive the liquid CO₂ through a tube-side inlet of the heat exchanger and to receive the gaseous CO₂ through a shell-side inlet of the heat exchanger after the gaseous CO₂ exits the refrigeration chamber, thereby pre-cooling the liquid CO₂ prior to the liquid CO₂ exiting a tube-side outlet of the heat exchanger and entering the refrigeration chamber.

In certain embodiments, the liquid CO₂ enters the tube side of the shell-and-tube heat exchanger at about −12° F. (−24.4° C.) to about 2° F. (−16.7° C.) and exits the tube side of the shell-and-tube heat exchanger at about −25° F. (−31.7° C.) to about −5° F. (−20.6° C.). The pressure of the liquid CO₂ is substantially the same at entry and exit of the tube side of the shell-and-tube heat exchanger, in certain embodiments the pressure being from about 239 psig (1,647 kPa) to about 300 psig (2,068 kPa).

In a further embodiment, the gaseous CO₂ enters the shell side of the shell-and-tube heat exchanger at about −80° F. (−62.2° C.) and about atmospheric pressure and exits the shell side of the shell-and-tube heat exchanger at about −50° F. (−45.6° C.) to about −20° F. (−28.9° C.) and about atmospheric pressure.

Greater than about 48%, and, in certain embodiments, at least about 55% of the liquid CO₂ is converted into solid CO₂ upon flashing withini the refiigeration chamber.

In certain embodiments, the shell-and-tube heat exchanger is a one pass tube-side straight-tube heat exchanger, a two pass tube-side straight-tube heat exchanger or a U-tube heat exchanger.

### BRIEF DESCRIPTION OF THE DRAWINGS

FIG. 1 is a schematic block diagram of a refrigeration chamber using a liquid CO₂ subcooler.

FIG. 2 is a cross-sectional view of one embodiment of the liquid CO₂ subcooler.

FIG. 3 is a schematic cross-sectional view of another embodiment of the liquid CO₂ subcooler, utilizing a one pass tube-side straight-tube heat exchanger.

FIG. 4 is a schematic cross-sectional view of another embodiment of the liquid CO₂ subcooler, utilizing a two pass tube-side straight-tube heat exchanger.

FIG. 5 is a schematic cross-sectional view of another embodiment of the liquid CO₂ subcooler, utilizing a U-tube heat exchanger.

### DETAILED DESCRIPTION

A process is provided for utilizing the energy contained in the gaseous refrigerant exhaust of a refrigeration chamber in order to pre-cool the liquid refrigerant entering the refrigeration chamber, resulting in a more efficient use of refrigerant.

Provided is a refrigeration process comprising supplying liquid CO₂ into a refrigeration chamber, flashing the liquid CO₂ into gaseous CO₂ and solid CO₂ within the refrigeration chamber in order to create a cooling effect, and exhausting gaseous CO₂ from the refrigeration chamber, wherein the liquid CO₂ passes through a tube-side of a shell-and-tube heat exchanger prior to entering the refrigeration chamber, and the gaseous CO₂ passes through a shell-side of the shell-and-tube heat exchanger after exiting the refrigeration chamber, thereby pre-cooling the liquid CO₂ in the heat exchanger prior to entering the refrigeration chamber.

Heat exchangers are well known in the art of refrigeration, and any suitable type of heat exchanger may be used for the purposes of the present process, as determined by one of skill in the art, and may include various types of shell-and-tube heat exchangers.

The heat transfer resulting in the cooling or freezing which takes place within the refrigeration process results generally from sublimation of the solid CO₂ which contacts the items which are disposed within the refrigeration chamber. Thus, an increased amount of solid CO₂ will result in a more efficient cooling process. By pre-cooling the liquid CO₂ entering the refrigeration chamber, a greater percentage of the liquid CO₂ is converted into solid CO₂ via the flash, that is, having conversion to greater than 48% solid CO₂ (or “snow”).

In certain embodiments, the liquid CO₂ enters the tube side of the shell-and-tube heat exchanger at about −12° F. (−24.4° C.) to about 2° F. (−16.7° C.) and exits the tube side of the shell-and-tube heat exchanger at about −25° F. (−31.7° C.) to about −5° F. (−20.6° C.). The pressure of the liquid CO₂ is substantially the same at entry and exit of the tube side of the shell-and-tube heat exchanger, in certain embodiments the pressure being from about 239 psig (1,647 kPa) to about 300 psig (2,068 kPa).

It is desirable that the pressure through the tube-side of the shell and tube heat exchanger remain substantially the same because a pressure drop through the tube-side may result in instability of the liquid stream, creating undesirable results such as solid CO₂ buildup within the tube-side of the heat exchanger.

In certain embodiments, the gaseous CO₂ enters the shell side of the shell-and-tube heat exchanger at about −80° F. (−62.2° C.) and about atmospheric pressure and exits the shell side of the shell-and-tube heat exchanger at about −50° F. (−45.6° C.) to about −20° F. (−28.9° C.) and about atmospheric pressure.

Greater than about 48%, and, in certain embodiments, at least about 55% of the liquid CO₂ is converted into solid CO₂ upon flashing within the refrigeration chambers and the temperature of said resulting gaseous CO₂ and solid CO₂ is less than about −109° F. (−78.3° C.). This results in a more efficient use of CO₂, resulting in cost savings due to a reduction in the amount of CO₂ required to achieve a desired refrigeration temperature.

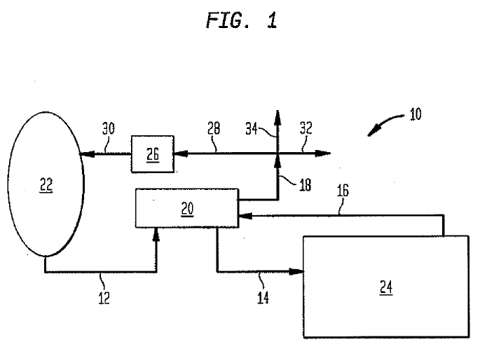

Referring now to FIG. 1, the refrigeration process apparatus 10 is comprised of a refrigeration chamber 24, a heat exchanger 20, a liquid CO₂ storage apparatus 22 and a recycle apparatus 26. The fresh CO₂ liquid 12 exits the liquid CO₂ storage apparatus 22 and enters the heat exchanger 20. Chilled CO₂ liquid 14 exits the heat exchanger 20 and enters the refrigeration chamber 24. Exhaust CO₂ gas 16 exits the refrigeration chamber 24 and enters the heat exchanger 20. Warmed CO₂ gas 18 exits the heat exchanger 20 and can be vented to the atmosphere 34, utilized in other processes 32, or recycled 28 by passing the warmed CO₂ gas through a recycle apparatus 26. If recycled, the CO₂ gas 30 exiting the recycle apparatus 26 is sent to the liquid CO₂ storage apparatus 22 to provide liquid CO₂ refrigerant.

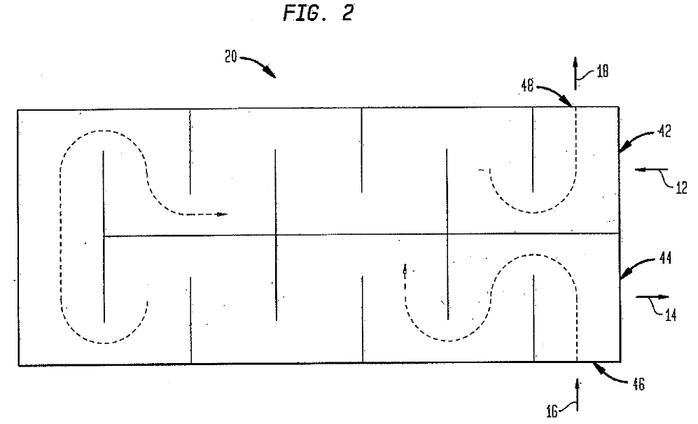

Referring now to FIG. 2, the portion of the refrigeration process as herein described utilizes a heat exchanger 20. The fresh CO₂ liquid 12 enters the heat exchanger at the tube-side fluid inlet 42. The chilled CO₂ liquid 14 exits the heat exchanger at the tube-side outlet 44. The exhaust CO₂ gas 16 exiting the refrigeration chamber enters the heat exchanger at the shell-side inlet 46. The warmed CO₂ gas 18 exits the heat exchanger at the shell-side outlet 48. The warmed CO₂ gas 18 can be scented to the atmosphere, can be utilized in other processes, or can be recycled to provide liquid CO₂ refrigerant.

In further embodiments, the shell-and-tube heat exchanger may comprise at least one of a one pass tube-side straight-tube heat exchanger, a two pass tube-side straight-tube heat exchanger, or a U-tube heat exchanger.

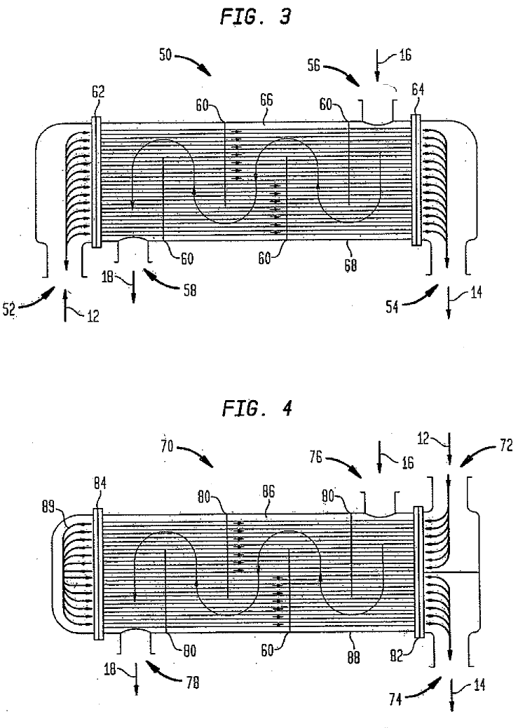

FIG. 3 shows a one pass tube-side straight-tube heat exchanger 50 useful according to the present process. The fresh CO₂ liquid 12 enters the heat exchanger 50 at the tube-side inlet 52 passes through: a first tube sheet 62; the tube bundle 66 which utilizes straight tubes; and a second tube sheet 64; before exiting the heat exchanger as chilled CO₂ liquid 14 at the tube-side outlet 54. The chilled CO₂ liquid 14 is then flashed upon entering the refrigeration chamber (not shown). The exhaust CO₂ gas 16 which exits the refrigeration chamber enters the heat exchanger shell 68 at the shell-side inlet 56, passes around the baffles 60 in order to permit increased heat transfer from the liquid CO₂ to the gaseous CO₂, thereby chilling the liquid CO₂ stream. The warmed CO₂ gas 18 then exits the shell 68 at the shell-side outlet 58. The warmed CO₂ gas 18 can be vented to the atmosphere, can be utilized in other processes, or can be recycled to provide liquid CO₂ refrigerant. In the embodiment shown, the colder exhaust CO₂ gas is initially in a heat exchange relationship with chilled CO₂ liquid.

FIG. 4 shows a two pass tube-side straight-tube heat exchanger 70 useful according to the present process. The fresh CO₂ liquid 12 enters the heat exchanger 70 at the tube-side inlet 72, passes through: the upper portion of a first tube sheet 82; the upper portion of a tube bundle 86 which utilizes straight tubes; and the upper portion of a second tube sheet 84 into a plenum 89. The liquid CO₂ is then redirected by the plenum 89 through: the lower portion of the second tube sheet 84; the lower portion of the tube bundle 86; and the lower portion of the first tube sheet 82; before exiting the heat exchanger as chilled CO₂ liquid 14 at the tube-side outlet 74. The chilled CO₂ liquid 14 is then flashed upon entering the refrigeration chamber (not shown). The exhaust CO₂ gas 16 which exits the refrigeration chamber enters the heat exchanger shell 88 at the shell-side inlet 76, passes around the baffles 80 in order to permit increased heat transfer from the liquid CO₂ to the gaseous CO₂, thereby chilling the liquid CO₂ stream. The warmed CO₂ gas 18 then exits the shell 88 at the shell-side outlet 78. The warmed CO₂ gas 18 can be vented to the atmosphere can be utilized in other processes, or can be recycled to provide liquid CO₂ refrigerant. In this embodiment the liquid CO₂ can transfer heat to the colder exhaust CO₂ gas in two passes: upon entry into the heat exchanger as it passes through the upper portion of the tube bundle, and again before exiting the heat exchanger as it passes through the lower portion of the tube bundle.

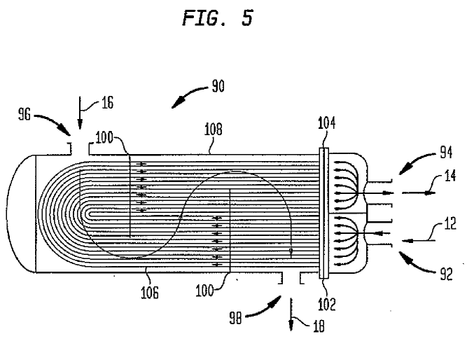

FIG. 5 shows a U-tube heat exchanger 90 useful according to the present process. The fresh CO₂ liquid 12 enters the heat exchanger 90 at the tube-side inlet 92, passes through: a first tube sheet 102; the tube bundle 106 which utilizes U-tubes; and a second tube sheet 104; before exiting the heat exchanger as chilled CO₂ liquid 14 at the tube-side outlet 94. The chilled CO₂ liquid 14 is then flashed upon entering the refrigeration chamber (not shown). The exhaust CO₂ gas 16 which exits the refrigeration chamber enters the heat exchanger shell 108 at the shell-side inlet 96, passes around the baffles 100 in order to permit increased heat transfer from the liquid CO₂ to the gaseous CO₂, thereby chilling the liquid CO₂ stream. The warmed CO₂ gas 18 then exits the shell 108 at the shell-side outlet 98. The warmed CO₂ gas 18 can be vented to the atmosphere, can be utilized in other processes, or can be recycled to provide liquid CO₂ refrigerant.

### EXAMPLE

Liquid CO₂ is provided to the tube-side of the heat exchanger at 1.7° F. (−16.8° C.) and 300 psig (2,068 kPa). The specific enthalpy of the saturated liquid stream before entering the heat exchanger is 19.6 BTU/lb (45.6 kJ/kg). Exhaust CO₂ in gaseous form exiting the refrigeration chamber is provided to the shell-side of the heat exchanger at −80° F. (−62.2° C.) and about atmospheric pressure. The enthalpy of the gaseous stream before entering the heat exchanger is 139.1 BTU/lb (323.5 kJ/kg). The exhaust comprises 80% of the liquid CO₂ which enters the refrigeration chamber. This process warms the exhaust gas by 30° F. (16.7° C.), therefore, the enthalpy of the gaseous stream exiting the heat exchanger would be 145 BTU/lb (337.3 kJ/kg) at a temperature of −50° F. (−45.6° C.).

The calculation to determine the subcooling achieved is: mass flow of the liquid stream times the change in enthalpy of the liquid stream is equal to mass flow of the gaseous stream times the change in enthalpy of the gaseous stream. Thus, where X will be the enthalpy of the liquid stream exiting the heat exchanger:

100×(19.6 BTU/lb−X)=80×(150.9 BTU/lb−145 BTU/lb)

Therefore, X is equal to 14.9 BTU/lb (34.7 kJ/kg), which corresponds to a liquid CO₂ temperature of approximately −8° F. (−22.2° C.) at 300 psig (2,068 kPa).

Without precooling, the heat of vaporization of saturated liquid CO₂ at 1.7° F. (−16.8° C.) and 300 psig (2,068 kPa) is 119.3 BTU/lb (277.5 kJ/kg). Utilizing the subcooler process according to the exemplified embodiment will result in a new heat of vaporization of 119.3 BTU/lb+change in enthalpy of the liquid CO₂ stream (19.6 BTU/lb−14.9 BTU/lb, or 4.7 BTU/lb). The new heat of vaporization of the now subcooled liquid stream will be 124.0 BTU/lb.

The increase in efficiency provided by the present process, utilizing, a liquid CO₂ subcooler process can be determined by the following formula:

$$1 - \frac{Non \text{-} Precooled Heat of Vaporization ( 119.3 ) }{Precooled Heat of Vaporization ( 124.0 )} \times 100 \%$$

This results in an efficiency increase of 3.8%. wichi shows that less CO₂ can be utilized in the refrigeration process.

The foregoing is just one non-limiting example illustrating a potential freezing efficiency increase obtained with one embodiment of the subject process. The gains in freezing efficiency increase with the increase in the temperature differential of the exhaust gas through the heat exchanger.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A refrigeration process, comprising supplying liquid CO₂ into a refrigeration chamber, flashing the liquid CO₂ into gaseous CO₂ and solid CO₂ to provide a cooling effect within the refrigeration chamber, and exhausting gaseous CO₂ from the refrigeration chamber, wherein the liquid CO₂ passes through a tube-side of a shell-and-tube heat exchanger prior to entering the refrigeration chamber and the gaseous CO₂ passes through a shell-side of the shell-and-tube heat exchanger after exiting the refrigeration chamber, thereby pre-cooling the liquid CO₂ prior to entering the refrigeration chamber.

2. The process of claim 1, wherein the liquid CO₂ enters the tube-side of the shell-and-tube heat exchanger at about −12° F. to about 2° F. and exits the tube-side of the shell-and-tube heat exchanger at about −25° F. to about −5° F., wherein the pressure of the liquid CO₂ is substantially the same at entry and exit of the tube-side of the shell-and-tube heat exchanger.

3. The process of claim 2, wherein the pressure of the liquid CO₂ as it passes through the shell-and-tube heat exchanger is about 239 psig to about 300 psig.

4. The process of claim 1, wherein the gaseous CO₂ enters the shell-side of the shell-and-tube heat exchanger at about −80° F. and about atmospheric pressure and exits the shell-side of the shell-and-tube heat exchanger at about −50° F. to about −20° F. and about atmospheric pressure.

5. The process of claim 1, wherein greater than about 48% of the liquid CO₂ is converted into solid CO₂ upon flashing within the refrigeration chamber.

6. The process of claim 1, wherein at least about 55% of the liquid CO₂ is converted into solid CO₂ upon flashing within the refrigeration chamber.

7. The process of claim 1, wherein the shell-and-tube heat exchanger is a one pass tube-side straight-tube heat exchanger.

8. The process of claim 1, wherein the shell-and-tube heat exchanger is a two pass tube-side straight-tube heat exchanger.

9. The process of claim 1, wherein the shell-and-tube heat exchanger is a U-tube heat exchanger.

10. A refrigeration apparatus comprising: a refrigeration chamber; a liquid CO₂ storage apparatus for providing liquid CO₂ at above atmospheric pressure to the refrigeration chamber for flashing into gaseous CO₂ and CO₂ snow; and a heat exchanger disposed between and in fluid communication with the storage apparatus and the refrigeration chamber for receiving and chilling the liquid CO₂ prior to said flashing; wherein the heat exchanger is a shell-and-tube heat exchanger adapted to receive the liquid CO₂ through a tube-side inlet of the heat exchanger and to receive the gaseous CO₂ through a shell-side inlet of the heat exchanger after the gaseous CO₂ exits the refrigeration chamber, thereby pre-cooling the liquid CO₂ prior to the liquid CO₂ exiting a tube-side outlet of the heat exchanger and entering the refrigeration chamber.

11. The refrigeration apparatus of claim 10, wherein the shell-and-tube heat exchanger is a one pass tube-side straight-tube heat exchanger.

12. The refrigeration apparatus of claim 10, wherein the shell-and-tube heat exchanger is a two pass tube-side straight-tube heat exchanger.

13. The refrigeration apparatus of claim 10, wherein the shell-and-tube heat exchanger is a U-tube heat exchanger.

14. The refrigeration apparatus of claim 10, further comprising a recycle apparatus for receiving warmed gaseous CO₂ from a shell side outlet of the heat exchanger.
